(19) United States
(12) Patent Application Publication
(10) Pub. No.: US 2003/0024956 A1
(43) Pub. Date: Feb. 6, 2003

(54) Confetti, theatrical snow, and fog launching mechanism and system

(76) Inventor: Gary Crawford, Lynnwood, WA (US)

Correspondence Address: Mark L. Lorbiecki, Esq., BLACK LOWE & GRAHAM, 816 Second Avenue, Seattle, WA, 98104, US

(21) Appl. No.: 10/142,676

(22) Filed: May 10, 2002

Related U.S. Application Data
(60) Provisional application No. 60/309,824, filed on Aug. 2, 2001.

(51) Int. Cl. B05B 7/14

(52) U.S. Cl. 222/637

(57) ABSTRACT

The invention is a system and method of deploying an air extractor to motivate a stream of air to entrain particles of confetti or snow like medium. An air extractor moves air by means of Bernoulli's principle. A venturi tube constricts a flow of air creating a localized low pressure area at the throat of the constriction. A vent at the constriction induces a flow of air from the ambient atmosphere to this low-pressure area

This application claims priority to provisional application serial No. 60/309,824 filed Aug. 2, 2001.

### FIELD OF THE INVENTION

This invention relates generally to theatrical effects and, more specifically, to dispersion of media.

### BACKGROUND OF THE INVENTION

Stage directors and others in the performing arts have struggled for a long time to produce realistic snowfall on stage. While media, such as paper confetti, Styrofoam bits, and soap flakes, have all served suitably as snow on both movies and theatrical sets, the means of launching media have been deficient. Additionally, stage directors have wanted to launch streamers and fog with the same equipment.

To meet this need several various means have been used. One such solution, Pickens, U.S. Pat. No. 6,082,594 issued Jul. 4, 2000, agitates a hopper with paddles above a sifting screen. While this method does produce a gentle simulated snowfall but the hoppers have finite capacity. In the course of a production, the hoppers must be either refilled at regular intervals or there must be some additional mechanical means to convey a steady stream of media to the hoppers.

A second method is to propel confetti and streamers in cannons pressurized by compressed air. Discrete loads of medium are loaded into the cannon and sudden discharge of gas will propel the medium to a discrete location. Shooting through such a cannon sends medium in compressed packets to the discrete location where, upon dispersion the display appears as a point sources. Such point sources are hard to blend into a natural snowfall.

Another approach is that of Austin, U.S. Pat. No. 6,149,495 issued Nov. 21, 2000. Austin employs an electric motor running a turbine-type fan. Air at the fan's intake is drawn across a hopper filled with medium. The airflow across the medium entrains bits of the medium in the airflow, which is then drawn through the turbine-type fan, through the exhaust of the fan, and then is directed to a location suitable to create the effect.

In addition, stage directors find that streamers and fog are not susceptible to turbine launch. Streamers are chopped by rotating turbine blades. Fog is mixed to the point of dispersion by the same blades. First, contact with the turbine blades simply ruins the medium. Second, where the particles of such a medium are easily damaged as would the medium used to simulate the slow fall of fluffy snow, the trip through the turbine-type fan blades can damage the individual particles of medium creating a disingenuous effect where as damaged particles fall much more rapidly to the floor. Such damaged medium is not reusable.

What is needed, then, is a confetti, theatrical snow, streamer, or fog entraining device that is quiet and allows for continuous use and reuse of the theatrical snow or confetti.

### SUMMARY OF THE INVENTION

The invention is a system and method of deploying an air extractor to motivate a stream of air to entrain particles of confetti or snow like medium. An air extractor moves air by means of Bernoulli's principle. A venturi tube constricts a flow of air creating a localized low-pressure area at the throat of the constriction. A vent at the constriction induces a flow of air from the ambient atmosphere to this low-pressure area. Using this moving flow to entrain particles of medium, the invention transports the particles without passing them through any sort of fan. Thus, the danger of damaging the particles or clogging a fan is alleviated.

The invention does not require a hopper of fixed dimensions. The induced air flow may be used to entrain as much of the medium as is necessary and can be constantly replenished. The invention requires no distinct conveyor but rather will continue to entrain particles of medium wherever the pickup is directed. In a preferred embodiment of the invention, the pickup can be used to draw medium off of a floor to constantly relaunch the medium. Such a cycle requires fewer particles for a better effect. So long as there is adequate supply available, the invented device can run continuously.

Embodiments of the invention may be used to launch fog. Even cooled fog (cooled to increase its density, making the fog tend to cling to the floor) will be transmitted across great lengths without dispersing the fog or warming it.

### BRIEF DESCRIPTION OF THE DRAWINGS

The preferred and alternative embodiments of the present invention are described in detail below with reference to the following drawings.

FIG. 1 is a cut away view of the air extraction nozzle used to motivate particles of media;

FIG. 2 is a cut away view of the air extractor nozzle deployed with a fan as an integrated unit;

FIG. 3 is the particulate flow path of particular media through the system; and

FIG. 4 is a flow chart depicting an example process performed by the devices shown in FIGS. 1 and 2.

### DETAILED DESCRIPTION OF THE PREFERRED EMBODIMENT

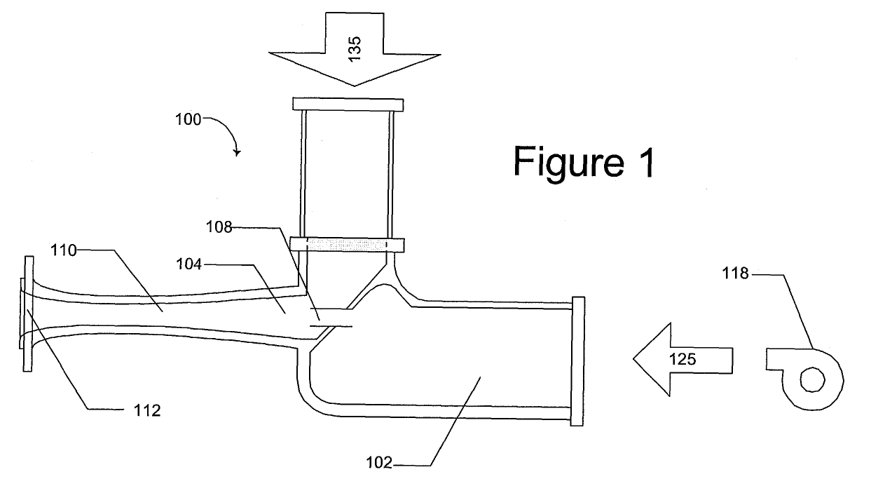

FIG. 1 shows a cutaway view of the air extractor nozzle in a preferred embodiment of the invention. An air extractor nozzle 100 includes first and second chambers 102, 104, connected by a communicating jet 108. The first chamber 102 is adjacent to the second chamber 104. The second chamber is elongated along the path of the jet 108 and opens into a horn 112 in communication with the environment. The elongation of the horn 112 connected to the second chamber 104 includes a constriction or venturi 110 to facilitate the Bernoulli Effect.

In operation, the first opening of the first chamber 102 receives a flow of pressurized air 125 from a fan assembly 118. The pressurized air 125 is released through the jet 108 into the second chamber 104 to produce a rapidly moving stream of air through the venturi 110, and into the horn 112. The pressure of the air within the moving stream drops at the venturi 110 according to the Bernoulli principle. As the pressure drops relative to the ambient air, the low pressure draws or entrains air from adjacent to the venturi 110 within the second chamber 104, resulting in a flow of air 135 from the environment adjacent to throw the venturi 110 and out the horn 112. The flow of entrained air 135 depends upon the volume and speed of the air flowing through the jet 108. As the fan assembly 118 delivers more air at greater pressures, the flow of entrained air 135 becomes greater.

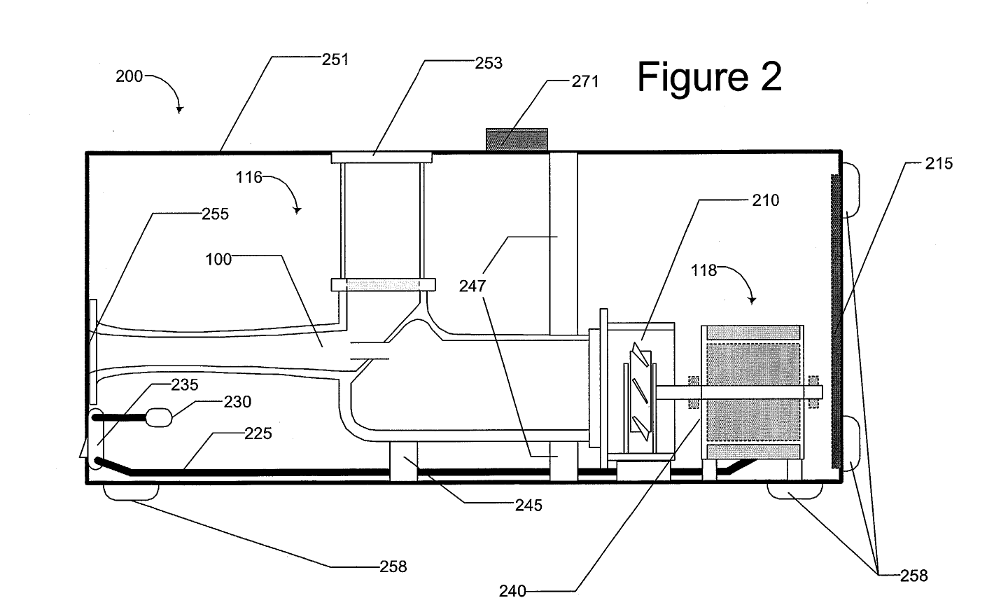

FIG. 2 displays an embodiment deploying the air extractor nozzle 100 and the fan assembly 118 as an integrated unit 200. The air extractor nozzle 100 is mounted and secured within a nozzle compartment 116 of a containing case 251 with an entry port 253 to the chamber 104 and an exit port 255 for the chamber 104. The air extractor nozzle 100 is mounted on one or more pillow blocks 245 and secured within a bulkhead 247 that separates the nozzle compartment 116 from the fan assembly 118 that is in a fan compartment. In the preferred embodiment, the bulkhead 247 divides the fan compartment from the nozzle compartment 116 but may provide a seal the fan compartment or the periphery of the ports 253 and 255 provide a seal. The fan compartment includes a venting port 215 with louvers on an exterior bulkhead of the containing case 251. The fan 210 feeds the air stream to the air extraction nozzle and a motor 240 that drives the fan 210. As the motor 240 drives the fan it generates the air stream 125 (FIG. 1). The venting port 215 can be located on more than one side of the integrated unit 200.

In the preferred embodiment, the fan 210, the motor 240, and the venting port 215 are configured so as to promote air flow through and cooling the motor 240. The utility of the venting port 215 is further enhanced when, in a preferred embodiment, acoustic foam acts as a filter and also prevents the promulgation of noise from the fan assembly 118 to the environment surrounding the containing case 251. Even without the acoustic foam, the louvers in the venting port 215 divert acoustic energy and disperse it into the ambient. Elastomeric feet 258 further enhance acoustical isolation from the environment surrounding the containing case 251. These feet 258 allow the unit 200 to rest either as shown in FIG. 2 or rotated to rest such that the port 255 is directed upward.

Also visible in FIG. 2 are optional features that enhance the invention's versatility in stage use. An internal electrical path allows remote control by alternately providing electrical power. The electrical path includes an internal electrical cord 225 connection the electrical motor 240 through a switch 235 and on to a male surface mount connector 230. In a preferred embodiment, this connector 230 is fused. By virtue of these connections, the fan assembly 118 can be controlled either by manually operating the switch 235, or with the switch 235 in the closed position, connecting the unit by the connector 230 to a suitably switched power line (not shown) providing, thereby, remote control of the unit.

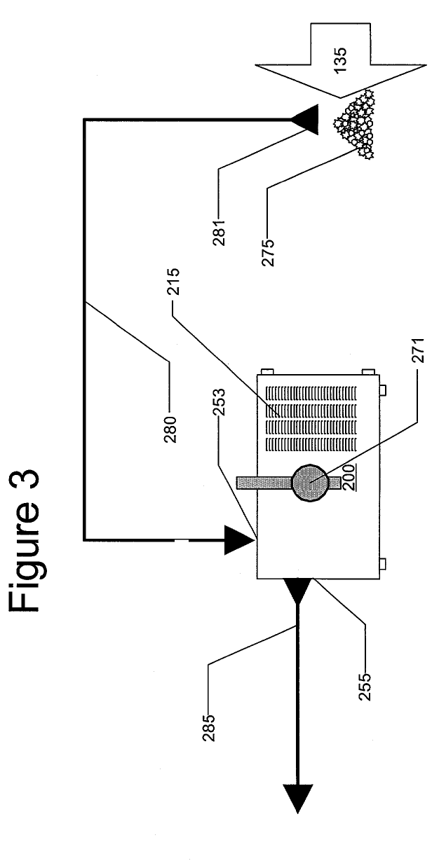

Additionally, a bracket 271 is mounted to the case 251. This bracket is articulatable and fixable at appropriate angles and extensions allowing an adjustable fixation point that can be suitably adjusted based upon application. This preferred embodiment is known in the art as “gimbel” mounting. This bracket 271 can be appropriately fixed to scaffolding, catwalks, and booms. Once the exit port 255 is suitably directed, the unit 200 can wait, dormant, until suitably energized through the connection 230. Upon energizing the connection 230, the unit 200 will launch such media as are available to the pickup 281 (FIG. 3).

FIG. 3 displays the path of the second airflow 135 through the device described above in FIG. 2. As discussed in FIG. 1, the gas extracting nozzle assembly 100 generates at least a partial vacuum at the intake port 253 when supplied with an air stream from the fan assembly 118 (FIG. 2). Ducting 280 such as hoses or tubes are used to conduct the localized relative vacuum at 253 along the hose to a pickup end 281 of the ducting 280. At the pickup end 281 the localized vacuum generates an airflow 135 that entrains particles of medium 275 much as the airflow to a vacuum cleaner might entrain particles of dust in a carpet. From the pickup end 281, the airflow 135 with the entrained particles of medium travels along the ducting 280 through the intake port 253 and through the air extractor nozzle out through the exit port 255 and along ducting 285 to the desired location. In this manner the particles of medium have never been in contact or even in close proximity to the fan assembly 118 (FIG. 2).

The unit 200 can be remotely mounted above a stage or proximate to the ceiling of a dancing establishment. From that position hoses lead to a remote area can supply confetti on demand. An operator can interrupt power flowing to the unit 200 to effectively control when the unit will project particles of medium. The medium itself may be stored in a hopper or with a conveyor belt to assure a constant feed to the pickup end 281. Similarly, if the pickup is on a flexible hose an operator can use the pickup end 281 directing it at supplies of particles of medium much as one might use a hand tool attachment to a vacuum cleaner.

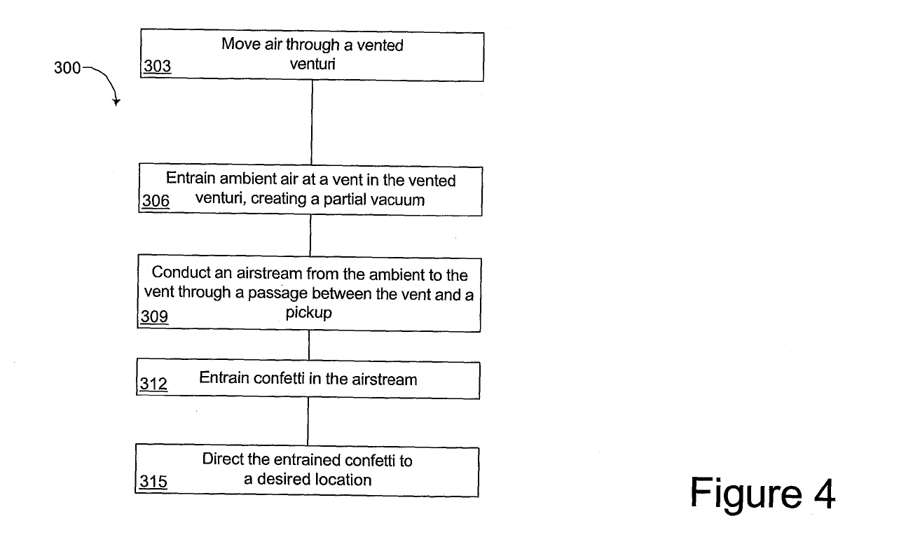

FIG. 4 illustrates a method 300 by which particles of medium are projected through the device shown and described above. First, at block 303, an airstream is generated and sent through a vented venturi. It will be readily appreciated that any means of motivating air through the venturi tube will work. The simplest embodiment, a bleed off a high pressure airline will suffice as will other embodiments such as an auxiliary fan or compressor. Even exotic technology such as an ion jet will serve to motivate the airflow. Any airflow will do.

The vented venturi tube has a constriction or venturi in the center. At the venturi the pressure within the moving stream of air drops due to the Bernoulli effect. The vent at the venturi takes ambient air at a higher pressure and draws it toward the low pressure. That movement of air entrains other gasses until a full stream of ambient air is generated, block 306.

The movement of the entrained air can be ducted at block 309. As with any localized low pressure zone, a hose or duct can be used to transfer that localized low pressure to a remote location. A hose for a vacuum cleaner demonstrates the principle. At a remote pickup, the localized low pressure zone draws air from the atmosphere surrounding the pickup causing an air stream to flow.

The flowing air stream entrains medium at block 312. As the flow enters the pickup, where medium is in close proximity to the pickup, the flow can entrain medium. As has been indicated in the preceding discussion, the air flows from the pickup, through the ducting, into the air extractor nozzle and out through the horn of the air extractor nozzle. With the air flow, so flows the medium. At block 315, the nozzle is directed where the flow of the medium is desired.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. An apparatus for dispersing particles of a medium such as confetti, such apparatus comprising:
an air extracting nozzle, including:
a communicating jet tube having a first end and a second end;
a first chamber having a port and connected to the communicating jet at the first end of the communicating jet;
a second chamber with a port and connected to the communicating jet at the second end of the communicating jet; and
a cylindrical venturi tube including:
a venturi constriction at the center of the cylindrical venturi tube;
an open end communicating to ambient environment; and
a fastened end communicating to the second chamber and in alignment with the communicating jet.

2. The apparatus of claim 1, wherein air is maintained in the first chamber at a pressure in excess of the ambient pressure.

3. The apparatus of claim 2, wherein a fan communicating with the port of the first chamber is used to maintain the air pressure in the first chamber.

4. The apparatus of claim 2, wherein a compressor communicating with the port of the first chamber is used to maintain the air pressure in the first chamber.

5. The apparatus of claim 2, wherein the second port includes a hose.

6. The apparatus of claim 5, wherein the hose includes a pickup.

7. The apparatus of claim 5, wherein the hose includes a hopper.

8. The apparatus of claim 1, further including a bracket.

9. The apparatus of claim 8, wherein the bracket is suitably used for affixing the apparatus to a suitable mount.

10. A method of dispersing particles of a medium, such as confetti, into an ambient environment at an ambient pressure, such method comprising:
moving air through a venturi tube;
entraining a flow of air at a venturi in the venturi tube;
conducting air from a pickup to supply the flow of entraining air;
entraining the particles in the conducted air; and
directing the conducted air and entrained particles into the ambient environment.

11. The method of claim 10, wherein moving air includes driving a fan.

12. The method of claim 10, wherein moving air includes driving a compressor.

13. The method of claim 10, wherein the medium is fog.

14. The method of claim 10, wherein the medium is streamers.

15. The method of claim 10, wherein the medium is confetti.

16. The method of claim 10, wherein the medium is theatrical snow.

17. An apparatus for dispersing particles of a medium such as confetti, such apparatus comprising:
a housing;
a venturi tube enclosed by the housing;
a fan for moving air through the venturi tube so as to produce a localized lowered pressure relative to an ambient air pressure;
a duct for conducting air from the ambient air pressure to the localized lowered pressure, the duct having a high-pressure end and a low-pressure end.

18. The apparatus of claim 17, wherein the duct includes a pickup at the high-pressure end.

19. The apparatus of claim 17, wherein the duct includes a hose.

20. The apparatus of claim 17, further having a bracket attached to the housing.
